(19) United States
(12) Patent Application Publication
(10) Pub. No.: US 2006/0193561 A1
(43) Pub. Date: Aug. 31, 2006

(54) Component and method for eccentric alignment of a first and a second pin, which each contain an optical fiber centrally, as well as a module assembly and a plug coupling having such a component

(76) Inventor: Jorg-Reinhard Kropp, Berlin (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/326,915

(22) Filed: Jan. 6, 2006

(30) Foreign Application Priority Data
Jan. 7, 2005 (DE) DE 102005000925.5

(51) Int. Cl. G02B 6/36

(52) U.S. Cl. 385/52; 385/78

(57) ABSTRACT

The invention relates to a component and a method for eccentric alignment of a first and a second pin, which each contain an optical fiber centrally, and to a module assembly and a plug coupling having such a component. The component according to the invention has an integral guide element and at least one pressure part which is connected to the guide element. The guide element has a first area, which is used to hold the first pin, a second area) which is axially adjacent to the first area and is used to hold the second pin, and an aperture hole, with at least one radial side opening being formed in the guide element in at least one of the two areas. In this case, each pressure part passes through a side opening and is suitable for exerting a spring force, which acts radially inwards, on a pin which is held in the corresponding area.

### REFERENCE TO RELATED APPLICATION

This application claims the benefit of the priority date of German patent application 10 2005 000 925.5, filed on Jan. 7, 2005, the contents of which is herein incorporated by reference in its entirety.

### FIELD OF INVENTION

The present invention relates to a component and a method for eccentric alignment of a first and a second pin, which each contain an optical fiber centrally, and to a module assembly and a plug coupling having such a component.

### BACKGROUND OF THE INVENTION

When optical waveguides are being optically coupled, in particular when a monomode optical waveguide is being optically coupled to a multimode optical waveguide, a lateral offset is typically provided between the two waveguide cores. An appropriate offset makes it possible to inject light into central radii areas of a multimode optical waveguide, in which the quality of the refractive index profile is generally better than in the center of the core of a multimode optical waveguide. The lateral offset between the two waveguide cores in general thus leads to an increase in the bandwidth for information transmission via a multimode optical waveguide.

A lateral offset between the waveguide cores of a monomode optical waveguide and of a multimode optical waveguide is described, for example in the Gigabit-Ethernet Standard (see Standard 1000 Base-LX 1 Gbit Ethernet, document IEEE STD. 802.3-2002 Section 38.11.4). In order to provide a desired offset, it is known on the one hand for two optical waveguides each to be fused to one another with a defined lateral offset in the course of producing a spliced joint. The ends of the two optical waveguides are each fitted with a plug, so that the resultant cable can be inserted into a transmission path with the fibers spliced in the center. These are also referred to as so-called “offset patchcords”.

On the other hand, it is known for special eccentric plug pins (also referred to as ferrules) to be produced in order to provide an offset, into which a fiber can be adhesively bonded with a lateral offset. End coupling of an eccentric plug pin and of a central plug pin makes it possible to provide a defined offset in the junction from a monomode optical waveguide to a multimode optical waveguide.

The prior art apparatuses for providing an offset between optical waveguides that are to be coupled are disadvantageously complex to manufacture, and are thus expensive. Furthermore, the use of eccentric sleeves to form an

offset for the coupling of rotationally symmetrical bodies is generally known. The use of eccentric sleeves for coupling optical waveguides in order to form an offset is in principle feasible, but is disadvantageously associated with complex adjustment or production, in order to ensure that a precisely defined offset is achieved.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The present invention is directed to a component and a method for eccentric alignment of a first and a second pin, which each comprise an optical fiber, which allow a defined offset to be produced between such pins and the optical fibers contained in them in a simple and cost-effective manner. A further aim is to provide a module assembly and a plug coupling having such a component.

Accordingly, the component of the present invention comprises an integral guide element, which has a first area which is used to hold the first pin, a second area, which is axially adjacent to the first area and is used to hold the second pin, and an aperture hole which extends through both areas and completely through the integral guide element. In this embodiment, at least one radial side opening is formed in the guide element in at least one of the two areas. The component furthermore has at least one pressure part, which is connected to the guide element. Each pressure part passes through an axial side opening and is suitable for exerting a spring force, which acts radially inwards, on a pin which is held in the corresponding area.

The present invention is thus distinguished by the arranging at least one of the pins to be coupled in an aperture hole in a guide element of the component with play (freedom of movement for adjustment purposes) with respect to the hole wall, and of pressing such a pin, which is arranged with play in the aperture hole, radially against the hole wall. The radial pressure is applied by means of at least one pressure part as well as at least one opening which is formed radially at the side in the guide element, and of thus producing an offset between the two pins and the optical waveguides which are arranged centrally in each of them.

In one embodiment of the invention, the aperture hole has a different diameter in the first area of the guide element than in the second area of the guide element. The hole elements which are provided in the aperture hole are both formed centrally in the guide element, so that they can be produced easily. The difference between the diameters of the hole elements is, in this example, equal to twice the value of an offset to be set between the first and the second pin.

In the first area, the aperture hole, in one example, has a diameter such that it is matched to the external diameter of the pin to be held, that is to say the pin is held stable in the hole. By contrast, in the second area, the aperture hole has a diameter which is larger than the diameter of the pin to be held in it, so that this pin is in principle arranged in the hole with play. In this example, the side opening is formed solely in the second area of the guide sleeve, with the guide pin that is held there being pressed by the pressure part against one wall of the corresponding hole element.

In addition, it is not necessary to form a side opening in only one of the areas of the guide element. In fact, one embodiment provides for a side opening to extend in both areas of the guide element, but for a pressure part to pass through the side opening in only one of the areas. In particular, the guide element in this embodiment is in the form of a slotted sleeve with two hole elements, which are formed centrally and have different diameters, wherein the area having the smaller diameter surrounds a pin held therein by a radially compressive spring force. Further, the pin which is held in the other area is pressed laterally by a pressure part against a wall of the hole element which is formed in this area.

In another aspect of the invention, the aperture hole once again has a different diameter in the first area relative to the second area. However, the hole elements which are formed in this way divide a common envelope line, so that one hole element is formed centrally and the other hole element is formed eccentrically in the guide element. An example such as this makes it possible to adjust the offset of the two pins with respect to one another depending on the pressure direction of the pressure part.

In one embodiment of this invention, a plurality of radial side openings which are formed offset with respect to one another are formed in the area of the guide element wherein the hole element having a larger diameter is formed. The pressure part can be adjusted relative to the guide element and passes through a different one of the side openings depending on the position, whereby the pressure direction of a pin which is inserted into the area with the hole element with the larger diameter, and thus the lateral offset of the pins, can be varied with respect to one another.

In a further embodiment of the invention, a radial side opening and a pressure part, respectively, are provided both in the first area and in the second area. Also, the diameter of the aperture hole is larger both in the first area and in the second area than the external diameter of the first and the second pin, and the two side openings are arranged offset with respect to one another both axially and in the circumferential direction. A first and a second pin, which are inserted into the first area and the second area, are each pressed laterally against the inner wall of the corresponding area, thus forming a specific lateral offset.

In this example, the aperture hole has the same diameter in the first and the second area. The side openings in this example are offset in the circumferential direction, in order to produce a lateral offset. The offset in the circumferential direction is about 180°, thus making it possible to produce a maximum offset.

In another embodiment of this invention, at least one of the areas forms a plurality of side openings which are formed offset with respect to one another in the circumferential direction. The pressure part of the respective area can be adjusted relative to the guide element, and passes through another of the side openings in each case, depending on the position, whereby the pressure direction of a pin which has been inserted into the respective area and thus the lateral offset of the pins can be varied or adjusted with respect to one another. A pin which is held in the corresponding area has a different offset with respect to the pin that has been inserted into the other area depending on which radial side opening the pressure part passes through.

The pressure part may be part of a sleeve which is plugged onto the guide element. In general, the pressure part may be any desired elastically deformable spring part which can move radially. It exerts a radial compression force on a pin which has been inserted into the guide element. The pressure part may in this case also be a component which is integrated in the guide element, that is to say it may be formed integrally with the guide element.

The method according to the invention for eccentric alignment of a first and of a second pin comprises initially inserting the pins into the guide sleeve, pressing with a pressure part at least one pin laterally against the inner wall of the guide element and through a radial side opening in the guide sleeve, and exerting a spring force, which acts radially inwards, on the pin which is held in the corresponding area. In this example, the aperture hole has a diameter in this area which is larger by a defined amount than the diameter of the pin which is inserted into that area, so that the pin would have play if the pressure part were not there.

In a first embodiment of the method, the aperture hole has a diameter in only one of the areas which is larger than the diameter of the pin which is inserted into this area. The pin that is inserted into this area has a radially acting spring force applied to it by means of a pressure part only in this area.

In a second embodiment of the method, the aperture hole has a diameter in both of the areas which is larger than the diameter of the pin which is inserted into the respective area. The second embodiment also has a pressure part applies a radially acting spring force to the pin which is inserted in both areas, with a spring force that is applied to the two pins in different directions. This variant makes it possible to use a guide sleeve which can be produced easily and has an aperture hole with a constant diameter.

Exemplary applications of the component according to the invention are on the one hand integrated into a module assembly for eccentric coupling of an optical plug to an optoelectronic module. On the other hand, these applications of the component are integrated into a plug coupling for eccentric optical coupling of two optical plugs.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention will be explained in more detail in the following text using a plurality of exemplary embodiments with reference to the figures, in which:

FIG. 1 is a sectional side view of a first exemplary embodiment of a component having an integral guide element and having a pressure part, with the guide element having a stepped aperture hole;

FIG. 2 is a sectional side view of a second exemplary embodiment of a component having an integral guide element and having a pressure part, with the guide element having an aperture hole with a constant diameter;

FIG. 3 is a sectional side view of a module assembly for eccentric coupling of an optical plug to an optoelectronic module, with the module assembly comprising a component as shown in FIG. 1, 2 or 6;

FIG. 4 is a sectional side view of a plug coupling for eccentric coupling of two optical plugs, with the plug coupling comprising a component as shown in FIG. 1, 2 or 6;

FIG. 5 is an end view of the offset between two pins which have been inserted into a component as shown in FIG. 2;

FIG. 6 is a sectional side view of a third exemplary embodiment of a component having an integral guide element and having a pressure part, with the guide element having an aperture hole with two areas of different diameter, and having a common envelope line;

FIG. 7 is an isometric view of an example of a pressure part; and

FIG. 8 is an end view diagram of an area of a guide element in which two side cutouts have been formed, offset in the circumferential direction, in the guide element.

### DETAILED DESCRIPTION OF THE INVENTION

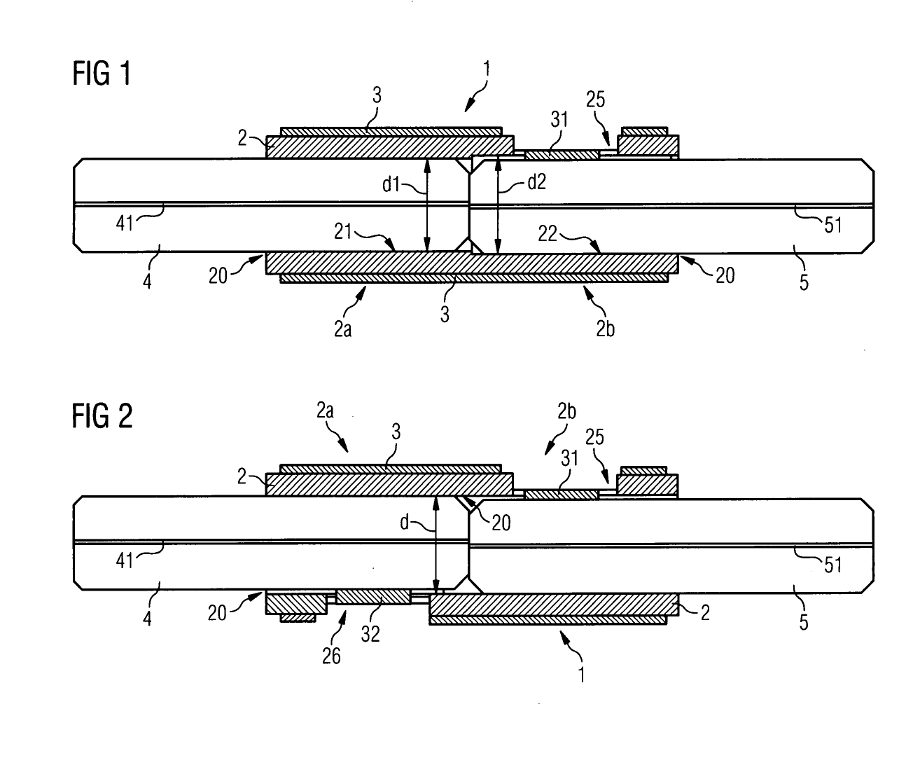

FIG. 1 shows a first exemplary embodiment of a component for eccentric alignment of two pins. The exemplary component 1 comprises an integral guide element 2 and a pressure element 3. In the illustrated exemplary embodiment, the guide element 2 is in the form of a cylindrical sleeve 2, which has a cylindrical aperture hole 20. The aperture hole 20 forms two hole elements 21, 22 of different diameter d1, d2. Accordingly, this results in a stepped aperture hole 20. The two areas 21, 22 of the aperture hole 20 are formed centrally in the guide element 2.

A radial side opening 25 is furthermore formed in the guide element 2 in the area in which the hole 22 with the larger diameter d2 is formed.

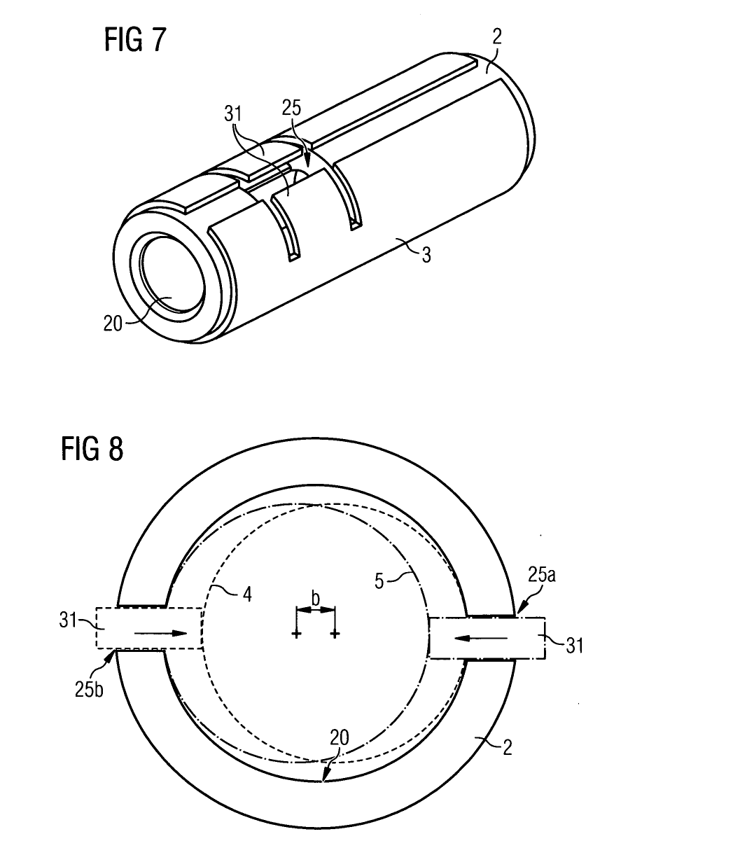

In the exemplary embodiment of FIG. 1, the pressure element 3 is in the form of a spring sleeve which is pushed onto the outside of the guide element 2. In this case, the spring sleeve 3 forms an area 31 which is sprung radially inwards, projects into the side opening 25 in the guide element 2 and passes through it. This radially sprung area forms a pressure part or a pressure spring 31. FIG. 7 shows an example of an embodiment of the spring sleeve 3 with two pressure springs 31. In the illustration in FIG. 7, however, the pressure springs 31 have not yet been bent in the direction of the opening 25, so that they pass through it. However, this does occur once the assembly process has been completed.

FIG. 1 illustrates that the component 1 is used to hold and couple two plug pins 4, 5, which contain an optical fiber 41, 51 centrally. Plug pins such as these are also referred to as ferrules, when they hold the end of an optical fiber. They are also referred to as fiber stubs, when they contain a small piece of optical fiber.

The plug pins 4, 5 are rotationally symmetrical and have a cylindrical shape. The diameters of the two pins 4, 5 are preferably, but not necessarily, identical.

The component 1 now forms a first area 2a in the hole element 21 with the smaller diameter d1, and this is used to hold one plug pin 4. The component 1 forms a second area 2b in the area of the hole element 22 with the larger diameter d2, and this is used to hold the second plug pin 5. The aperture hole 21 is in this case of such a size in the area 2a of the smaller diameter d1 that it closely matches the external diameter of the plug pin 4 inserted therein, thus providing stable guidance for the plug pin 4 in the component 1. For this purpose, the aperture hole, for example, may have a diameter in the area 21 under consideration which is approximately 1 to 3 μm larger than the external diameter of the pin 4. This allows insertion with relatively little force being applied, while at the same time ensuring that the inserted pin 4 is in a defined or predetermined position in the area under consideration.

By contrast, the aperture hole is designed, in the area of the hole element 22 with the larger diameter d2, such that it is larger by a defined amount than the external diameter of the pin 5 to be guided therein, so that the pin 5 is in general arranged with radial play in the hole element 22. The diameter d2 in the area of the hole element 22 is in this embodiment chosen such that it is enlarged with respect to the smaller diameter d1 by about twice the value of the desired offset between the two pins 4, 5 and of the optical fibers 41, 52 which are arranged centrally therein.

Since the two holes 21, 22 are formed centrally, these can be produced with high accuracy relatively easily.

The plug pin 5 which is inserted into the hole element 22 with the larger diameter d2 is guided without any play in this hole 22 because of pressure exerted by the compression spring 31 which projects through the opening 25, but in fact is pressed by the pressure spring 31 against the wall opposite the pressure spring 31. The force which is exerted radially on the pin 5 by the pressure spring 31 is of such a magnitude that the pin 5 is held stable in its position, yet allows it to be inserted into or withdrawn from the guide element 2 relatively easily. The desired lateral offset can be set very precisely by the pressure on one side of the pin 5.

For example, this embodiment is independent of the location of the cutout 25 within the guide element 2. The desired offset is set by virtue of the central arrangement of the two hole elements 21, 22 for any desired arrangement of the side opening 24 and of the pressure spring 31 which passes therethrough. There is therefore no relationship between the offset and the circumferential position of the pressure spring. In principle, this pressure spring can act at any desired point on the pin 5 which is arranged in the area element 22 with the larger diameter.

In one exemplary embodiment, light is injected from a monomode glass fiber into a 50 μm gradient index fiber. In this example, a lateral offset of 15 μm is required between the fiber cores. If the pins 4, 5 have an external diameter of 2.5 mm, then one hole element 21 is provided with a diameter d1 of 2.501 mm, and the other hole element is provided with a diameter d2 of 2.530 mm. Taking into account a tolerance of 1 μm, with which one pin 4 is inserted into the hole element 21 with the smaller diameter, the difference of 29 μm corresponds to precisely twice the desired offset.

FIG. 2 shows an alternative exemplary embodiment of a component 1 for eccentric alignment of two pins 4, 5, in which an aperture hole 20 with a constant diameter is provided. This embodiment therefore does not require a stepped aperture hole, which is advantageous for simpler production.

In addition to the aperture hole with a constant diameter d, the refinement shown in FIG. 2 differs from the refinement shown in FIG. 1 by a cutout 25, 26, respectively, being provided not only in the area 2b of the guide element 2 which holds one pin 5, but also in the area 2a of the guide element 2 which holds the other pin 4. As is shown in FIG. 1, a pressure spring 31, 32 is provided in the area of each cutout 25, 26, and is part of a spring sleeve 3, which is in the form of a sleeve and is pushed onto the guide element 2. The pressure springs 31, 32 are prestressed and project into the interior of the guide element 2.

The aperture hole 20 now has a diameter d of such a size that it is larger by a defined amount than the external diameter of the inserted pins 4, 5, so that, in principle, each of the two plug pins 4, 5 is arranged with a specific amount of radial play in the aperture hole 20. However, the springs 31, 32 press the respective pin 5, 4 against the respective opposite wall of the aperture hole 20. Since the side openings 25, 26 and the pressure springs 31, 32 which project through them are formed on opposite sides of the guide element 2 (offset through 180°), the pressure against the respective opposite wall leads to a desired, defined offset between the two pins 4, 5 and the optical waveguides 41, 51 which are contained centrally therein. FIG. 5 schematically illustrates these features.

The aperture hole 20 in the guide element 2 has a larger diameter than the diameter of the pins 4, 5 which are arranged in the guide hole and whose external dimensions are shown respectively by a dotted line and a dashed-dotted line in FIG. 5. The pressure spring 31 presses against the pin 5 and the pressure spring 32 presses against the pin 4, thus producing the desired offset between the two axis of the pins 4, 5, and accordingly between the optical waveguides which are contained centrally in the pins.

In a modification of the exemplary embodiment described in FIG. 2, it is also possible to provide for the two side openings 25, 26 and the associated pressure springs 31, 32. The openings and pressure springs may generally be arranged with an angular offset of less than 180° with respect to one another. Depending on the angular offset, for example, it is possible to set precisely an offset which adjusts from a maximum with an angular offset of 180° to a minimum of 0 with an angular offset of 0°.

Furthermore, in one development, it is possible to provide for a plurality of side cutouts, in particular two or three side cutouts. Such cutouts may be formed in the guide element 2 in the area 2a which holds one pin 4 and/or in the area 2b which holds the other pin 5, such that they are offset in the circumferential direction. In this example, movement of the spring element of the area under consideration with respect to the guide element 2 would make it possible for this guide element 2 to project into different ones of these openings, in which case it would always project into only one of the openings at one specific time. Accordingly, the offset between the two pins 4, 5 can be adjusted by choice of the opening into which the spring element projects. For example, in an embodiment such as this, the spring element 31 in one area 2b may have the capability to be rotated with respect to the guide element, independently of the spring element 32 in the other area 2a. For example, the spring sleeve 3 may be formed in two parts for this purpose.

FIG. 8 shows one exemplary embodiment relating to this development, which shows a section through the area 2b of the guide element 2. Two side openings 25a, 25b are formed offset through 180° in the circumferential direction in the guide element 2, through which a pressure part 31 projects. In this case, by way of example, a U-shaped spring is provided, whose two ends form two opposite pressure parts 31. Depending on the desired offset, one pressure part 31 or the other projects into the corresponding opening 25a, 25b. The corresponding positions of the sleeve 5 are illustrated by a dotted line and by a dashed-dotted line, respectively. The sleeve 5 can be moved radially between two positions depending on the opening 25a, 25b through which a pressure part 31 projects, with the distance between these two positions being b. When the sleeve 4 is in a fixed position in the other section 2a, the offset between the sleeves 4, 5 can be varied by the value b.

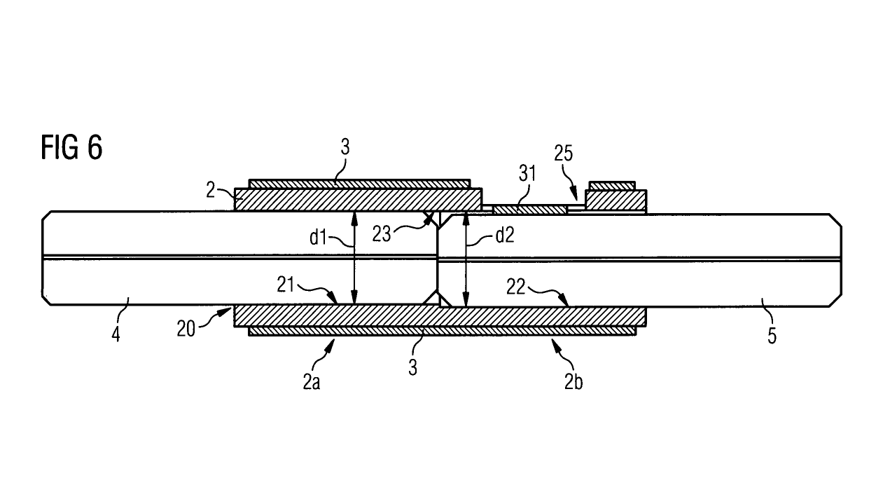

FIG. 6 shows a third exemplary embodiment, in which the aperture hole 20 has a step in the same way as in FIG. 1, but in which case a common continuous envelope line 23 is provided at the same time. This means that one of the two hole elements 21, 22 is formed eccentrically in the guide element 2.

Once again, a side opening 25 with a pressure spring 31 arranged therein is provided in the area 2b with the larger diameter d2 of the guide element, with the pressure spring 31 pressing an inserted plug pin 5 against the opposite wall, so that it is possible to set a defined offset. The arrangement of the pin 4 in the area 2a with the smaller diameter d1 has been described with reference to FIG. 1.

In the example embodiment of FIG. 6, the offset is, however, in contrast to the example shown in FIG. 1 not independent of the pressure direction. When the pressure spring 31 is in the position illustrated in FIG. 6, the offset is at a maximum. The area 2b with the enlarged diameter may now have a plurality of side openings, for example two or three, corresponding to FIG. 8. By movement of the spring sleeve 3 with respect to the guide element 2 it is possible for the pressure spring 31 to engage in different ones of these openings, and this leads to a different offset. This scheme allows the offset to be adjusted.

In a modification of the embodiment of FIGS. 1 and 6 (not illustrated), the guide element 2 takes the form of a slotted sleeve which has a slot over its entire length. The internal diameter of the slotted sleeve is in this example slightly smaller (approximately 1 to 3 μm) in the area 2a with the smaller diameter d1 than the external diameter of the pin 5. The sleeve is thus firmly seated on one pin 4. The slotted sleeve in this case has a second area with a larger diameter, in the same way as in FIGS. 1 and 6, in which a pressure spring projects into the sleeve interior. The side opening is in this case produced by the slot in the slotted sleeve.

There is therefore no need for the side opening to extend only in the area in which the hole element 22 with the larger diameter d2 is formed. In fact, the pressure spring passes through the side opening 25 only in this area of the hole element 22.

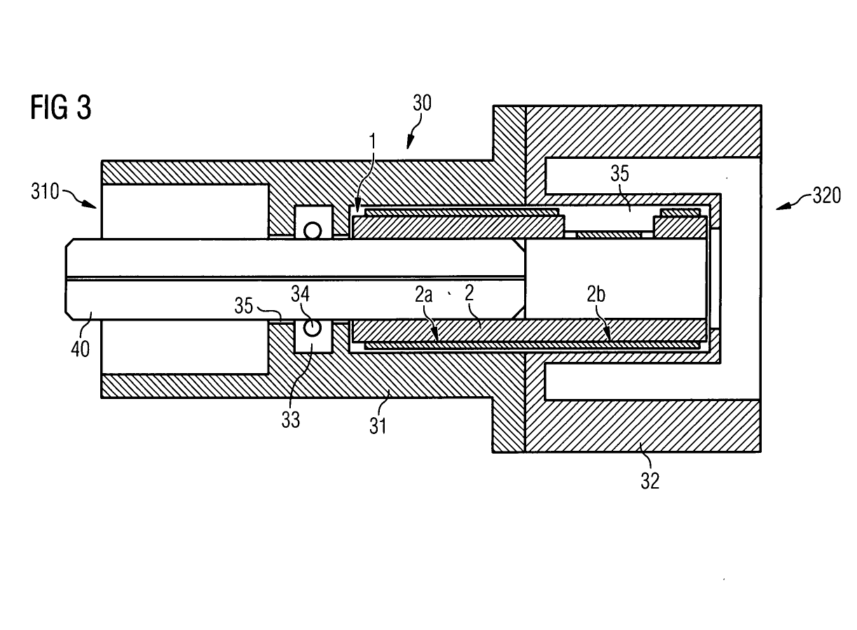

FIG. 3 shows a module assembly which allows eccentric coupling of an optical plug to an optoelectronic module, for example to an optoelectronic transceiver, and shows an adapter for this purpose. The module assembly 30 has a housing 30 which, in the illustrated exemplary embodiment may have two parts comprising housing elements 31, 32 which are firmly connected to one another. That end 310 of the first housing element which is remote from the other area element 32 is designed in such a way that it can be inserted into a plug socket in an optoelectronic module. That end 320 of the second housing element 32 which is remote from the housing element 31 is in contrast designed in such a way that it may take the form of a plug socket for holding an optical plug. The geometries which are illustrated in FIG. 3 in this case should be regarded only as examples and depend on the nature of the plug and of the plug socket. Further, typical components of a plug or of a plug socket, such as pressure springs, may also be utilized.

Approximately centrally, the module assembly 30 has an elongated cutout 35 in which a component as shown in FIGS. 1, 2 or 6 is arranged. In this example FIG. 3 does not show any details of the component 1, such as the stepped aperture hole (FIG. 1, FIG. 6) or the use of a second pressure spring (FIG. 2).

A fiber stub 40 is inserted into one holding area 2a of the sleeve 2 of the component 1. The fiber stub 40 extends through an aperture hole 35 in the first housing element 31 into the area 310 for coupling to an optoelectronic module. The fiber stub 40 is in this case mounted with a small amount of play axially and radially in the housing 30 or the housing element 31, by means of a circlip 34 or the like which is arranged in a cutout 33.

The component 1 is mounted together with the fiber stub 40 in the module assembly 30 in a floating manner, preferably both in the radial direction and in the axial direction. This makes it possible for the housing to absorb any external forces, for example forces resulting from pulling on a cable, while there are essentially no forces in the housing interior.

A plug pin of an optical plug (not illustrated) is inserted into the other area 2b of the guide element 2 during insertion of the plug into the plug holder 320, and in the process is aligned centrally with respect to the fiber stub 40. This represents end coupling.

The module assembly 30 thus allows eccentric coupling of an optical plug to an optoelectronic module, for example a transceiver.

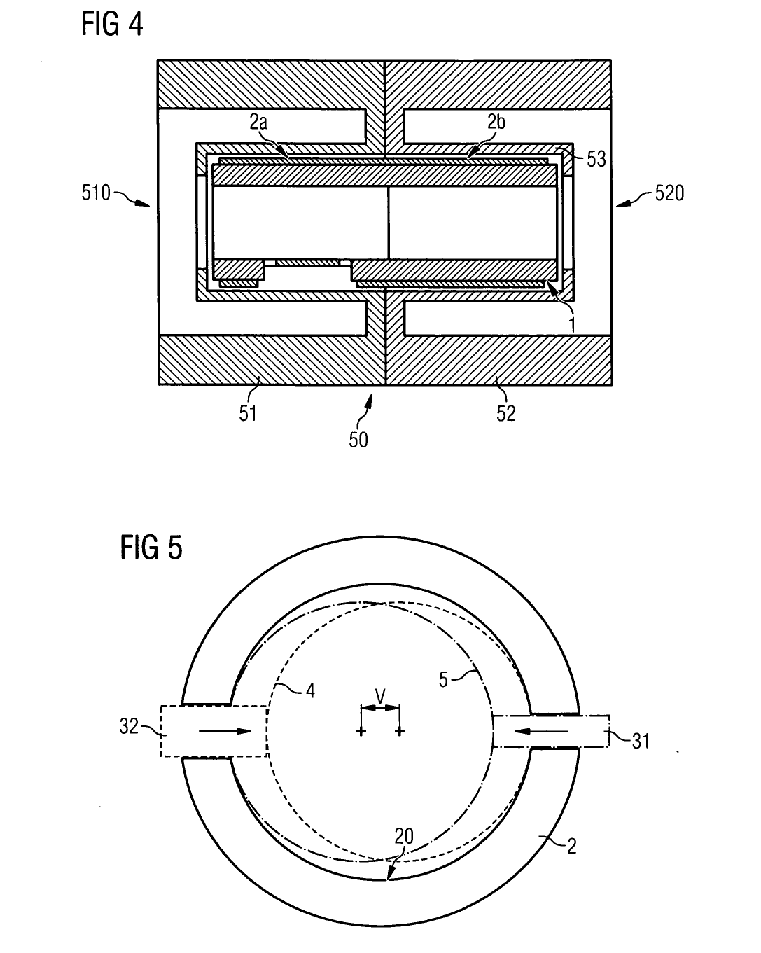

FIG. 4 shows a further use of a component 1 as described in FIGS. 1, 2 or 6. This represents a plug coupling 50 which is used for optical coupling of two optical plugs, and of the optical fibers contained in them. Each plug in this example has a plug pin which is inserted into a corresponding area 2a, 2b in the component 1, with the plugs being coupled eccentrically, as described with reference to FIGS. 1, 2 or 6.

The plug coupling has a housing which, for example, comprises two symmetrical housing elements 51, 52, which are firmly connected to one another, for example by adhesive bonding, riveting or ultrasound welding. Each housing element 51, 52 forms a plug socket 510, 520 for holding an optical plug. The detailed configuration of the plug socket depends on the optical plugs that are used. A sleeve 53 is formed centrally in the two housing elements 51, 52, with a component 1 as shown in FIGS. 1, 2 or 3 arranged in the sleeve 53 and mounted in a floating manner. Similar to FIG. 3, details of this component 1, such as a stepped aperture hole or the use of a plurality of pressure springs, are not illustrated separately, for the sake of simplicity.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A component for eccentric alignment of a first and a second pin which each contain an optical fiber centrally, comprising:
an integral guide element having
a first area which is used to hold the first pin;
a second area, which is axially adjacent to the first area and is used to hold the second pin, and
an aperture hole which extends through both areas and completely through the integral guide element; and
at least one radial side opening being formed in the guide element in at least one of the two areas; and
at least one pressure part, which is connected to the guide element;
wherein each pressure part passes through a side opening and is suitable for exerting a spring force, which acts radially inwards, on one of the first and second pins which is held in the corresponding area.

2. The component of claim 1, wherein the aperture hole has a different diameter in the first area of the guide element than in the second area) of the guide element, and hole elements which are provided in the aperture hole are both formed centrally in the guide element.

3. The component of claim 2, wherein the difference between the diameters of the hole elements is equal to twice the value of an offset to be set between the first and the second pin.

4. The component of claim 2, wherein the aperture hole in the first area has a diameter such that it is matched to the external diameter of the pin to be held, and the aperture hole has a diameter in the second area which is larger than the diameter of the pin to be held in it, with a side opening being formed solely in the second area of the guide sleeve.

5. The component of claim 2, wherein a side opening is provided in both areas of the guide element, but with a pressure part passing through the side opening in only one of the areas.

6. The component of claim 5, wherein the guide element is in the form of a slotted sleeve with two hole elements, which are formed centrally and have different diameters.

7. The component of claim 1, in which the aperture hole has a different diameter in the first area and in the second area, and the hole elements which are formed in this way divide a common envelope line, with one hole element being formed centrally and the other hole element being formed eccentrically in the guide element.

8. The component of claim 7, wherein the aperture hole has a diameter in the first area such that it is matched to the external diameter of the pin to be held, and the aperture hole has a diameter in the second area which is larger than the diameter of the pin to be held in it, with a side opening being formed solely in the second area of the guide sleeve.

9. The component of claim 7, wherein a plurality of radial side openings which are formed offset with respect to one another in the circumferential direction are formed in the area of the guide element in which the hole element of larger diameter is formed,
the pressure part can be moved relative to the guide element, and
the pressure part) passes through a different one of the side openings depending on the position,
whereby the pressure direction of a pin which is inserted into the area with the hole element with the larger diameter, and thus the lateral offset of the pins, can be varied with respect to one another.

10. The component of claim 1, wherein a radial side opening and a pressure part, respectively, are provided both in the first area and in the second area, with the diameter of the aperture hole being larger both in the first area and in the second area than the external diameter of the first and the second pin, and the two side openings being arranged offset with respect to one another both axially and in the circumferential direction.

11. The component of claim 10, wherein the aperture hole has the same diameter in the first and the second area.

12. The component of claim 10, wherein the two side openings are formed in the guide element such that they are offset through 180° in the circumferential direction.

13. The component of claim 10, wherein
at least one of the areas forms a plurality of side openings which are formed offset with respect to one another in the circumferential direction,
the pressure part of the respective area can be moved relative to the guide element and passes through a different one of the side openings in each case, depending on the position,
whereby the pressure direction of a pin which has been inserted into the respective area and thus the lateral offset of the pins, can be varied with respect to one another.

14. The component of claim 1, wherein the pressure part is part of a sleeve which is plugged onto and substantially surrounds the guide element.

15. The component of claim 1, wherein the pressure part is an elastically deformable spring part, which can move radially.

16. A method for eccentric alignment of a first and of a second pin, which each contain an optical fiber centrally, having the following steps:
providing an integral guide element having
a first area which is used to hold the first pin;
a second area, which is axially adjacent to the first area and is used to hold the second pin;
an aperture hole which extends through both areas and completely through the integral guide element;
at least one radial side opening being formed in the guide element in at least one of the two areas; and
wherein at least one of the areas having a diameter which is larger by a defined amount than the diameter of the pin which is inserted into that area;
inserting the first pin into the first area;
inserting the second pin into the second area; and
exerting lateral pressure on at least one pin against the inner wall of the guide element by means of a pressure part which passes through the side opening, and exerts a spring force, which acts radially inwards, on the pin which is held in the corresponding area.

17. The method of claim 16, wherein the aperture hole has a diameter in only one of the areas which is larger than the diameter of the pin which is inserted into this area, wherein the pin that is inserted therein has a radially acting spring force applied to it by means of a pressure part only in this area.

18. The method of claim 16, wherein the aperture hole has a diameter in both of the areas which is larger than the diameter of the pin which is inserted into the respective area, and a pressure part applies a radially acting spring force to the pin which is inserted there in both areas, with a spring force being applied to the two pins in different directions.

19. A module assembly for eccentric coupling of an optical plug to an optoelectronic module, comprising:
a housing with a first coupling face and a second coupling face which are opposite one another;
a component for eccentric alignment of a first and a second pin which each contain an optical fiber centrally, comprising:
an integral guide element having
a first area which is used to hold the first pin;
a second area, which is axially adjacent to the first area and is used to hold the second pin, and
an aperture hole which extends through both areas and completely through the integral guide element; and
at least one radial side opening being formed in the guide element in at least one of the two areas; and
at least one pressure part, which is connected to the guide element;
wherein each pressure part passes through a side opening and is suitable for exerting a spring force, which acts radially inwards, on one of the first and second pins which is held in the corresponding area;
the first coupling face configured for insertion into a plug socket of an optoelectronic transceiver;
the second coupling face forming a plug socket for holding an optical plug;
a fiber stub arranged in the first area of the guide element of the component and projecting into the first coupling face of the housing; and
the second area of the guide element of the component projecting into the second coupling face of the housing used to hold the pin of an optical plug which may be coupled thereto.

20. The module assembly of claim 19, wherein the housing has an inner sleeve in which the component and the fiber stub are arranged to float therein.

21. A plug coupling for eccentric optical coupling of two optical plugs, comprising:
a housing which forms a plug socket for holding an optical plug on opposite faces therein; and
a component which is arranged in the housing, for eccentric alignment of a first and a second pin which each contain an optical fiber centrally, comprising:
an integral guide element having
a first area which is used to hold the first pin;
a second area, which is axially adjacent to the first area and is used to hold the second pin, and
an aperture hole which extends through both areas and completely through the integral guide element; and
at least one radial side opening being formed in the guide element in at least one of the two areas; and
at least one pressure part, which is connected to the guide element;
wherein each pressure part passes through a side opening and is suitable for exerting a spring force, which acts radially inwards on one of the first and second pins which is held in the corresponding area.

22. The plug coupling of claim 21, wherein the housing has an inner sleeve in which the component is arranged to float therein.

23. The plug coupling of claim 21, wherein the housing comprises two symmetrical housing elements which are connected to one another.
